(19) United States
(12) Patent Application Publication
(10) Pub. No.: US 2021/0065468 A1
(43) Pub. Date: Mar. 4, 2021

(54) SYSTEMS AND METHODS FOR ARTIFICIAL INTELLIGENCE IN A VEHICLE SERVICE ENVIRONMENT

(71) Applicant: Honda Motor Co., Ltd., Tokyo (JP)

(72) Inventors: Stephenie Hei-Man Chung, San Pedro, CA (US); Brian David Bell, Long Beach, CA (US); Anthony Duane Williams, JR., Long Beach, CA (US); Christopher D. Santos, Long Beach, CA (US); Kevin Prettner, Torrance, CA (US); Charlie Jiakang Chen, Santa Fe Springs, CA (US); Mrinmoy Mallik, Diamond Bar, CA (US); Baburaj Nair, Torrance, CA (US)

(21) Appl. No.: 17/011,576

(22) Filed: Sep. 3, 2020

Related U.S. Application Data
(60) Provisional application No. 62/895,110, filed on Sep. 3, 2019.

(51) Int. Cl. G07C 5/00; G06N 20/00; G06N 5/04; G07C 5/08

(52) U.S. Cl. CPC G07C 5/006; G06N 20/00; G07C 5/085; G07C 5/008; G07C 5/0825; G06N 5/04

(57) ABSTRACT

A computer device for validating the installation of a part in a device is provided. The computer device is programmed to receive a first image of a device identifier for the device, receive a second image of a part identifier for the part, receive a third image of serial identifier the part, compare the device identifier, the part identifier, and the serial identifier to validate the part, receive a fourth image of the part after installation, determine whether the part was properly installed based on the fourth image, if the determination is that the part was not properly installed, instruct the display device to display a notification that the part was improperly installed, and if the determination is that the part was properly installed, store installation information.

### CROSS REFERENCE TO RELATED APPLICATIONS

This application claims priority to is a continuation of U.S. Patent Application Ser. No. 62/895,110 filed on Sep. 3, 2019, entitled “SYSTEMS AND METHODS FOR AUGMENTED REALITY IN A VEHICLE SERVICE ENVIRONMENT”, which is hereby incorporated by reference in its entirety.

### BACKGROUND

The field of the invention relates generally to artificial intelligence, and more specifically to systems and methods for providing artificial intelligence feedback in a vehicle service and maintenance environment.

In many cases, improper installation of a part in a vehicle can lead to the vehicle not working properly, which can lead to expensive additional repairs and safety issues. Furthermore, certain models of parts are specifically designed for specific models of vehicles. In addition, the same part may be installed in different models of vehicles in different manners, orientations, positions, and locations. Moreover, work orders and repair orders are for specific parts. Accordingly, it would be advantageous to ensure that the correct part is properly installed in the correct vehicle.

### BRIEF DESCRIPTION

In one aspect, a computer device for validating the installation of a part in a device is provided. The computer device includes at least one memory in communication with at least one processor. The at least one processor is also in communication with a camera and a display device. The at least one processor is programmed to receive, via the camera, a first image of a device identifier for the device. The at least one processor is further programmed to receive, via the camera, a second image of a part identifier for the part to be installed into the device. The at least one processor is also programmed to receive, via the camera, a third image of a serial identifier of the part to be installed into the device. In addition, the at least one processor is programmed to compare the device identifier, the part identifier, and the serial identifier to validate the part. Moreover, the at least one processor is programmed to receive, via the camera, a fourth image of the part after installation. Furthermore, the at least one processor is programmed to determine whether the part was properly installed based on the fourth image. If the determination is that the part was not properly installed, the at least one processor is programmed to instruct the display device to display a notification that the part was improperly installed. If the determination is that the part was properly installed, the at least one processor is programmed to store installation information.

In another aspect, a computer-implemented method for validating the installation of a part in a device is provided. The method implemented by a computer device including at least one memory in communication with at least one processor. The at least one processor is also in communication with a camera and a display device. The method includes receiving, via the camera, a first image of a device identifier for the device. The method also includes receiving, via the camera, a second image of a part identifier for the part to be installed into the device. The method further includes receiving, via the camera, a third image of a serial identifier of the part to be installed into the device. In addition, the method includes comparing the device identifier, the part identifier, and the serial identifier to validate the part. Moreover, the method includes receiving, via the camera, a fourth image of the part after installation. Furthermore, the method includes determining whether the part was properly installed based on the fourth image. If the determination is that the part was not properly installed, the method includes instructing the display device to display a notification that the part was improperly installed. If the determination is that the part was properly installed, the method includes storing installation information.

In a further aspect, a system for validating the installation of a part in a device is provided. The system includes at least one memory, a camera, a display device, and at least one processor in communication with the at least one memory, the camera, and the display device. The at least one processor is programmed to receive, via the camera, a first image of a device identifier for the device. The at least one processor is also programmed to receive, via the camera, a second image of a part identifier for the part to be installed into the device. The at least one processor is further programmed to receive, via the camera, a third image of a serial identifier of the part to be installed into the device. In addition, the at least one processor is programmed to compare the device identifier, the part identifier, and the serial identifier to validate the part. Moreover, the at least one processor is programmed to receive, via the camera, a fourth image of the part after installation. Furthermore, the at least one processor is programmed to determine whether the part was properly installed based on the fourth image. If the determination is that the part was not properly installed, the at least one processor is programmed to instruct the display device to display a notification that the part was improperly installed. If the determination is that the part was properly installed, the at last one processor is programmed to store installation information.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a simplified data flow diagram of a process for using artificial intelligence to ensure the correct part is properly installed in a vehicle in accordance with one embodiment of the disclosure.

FIG. 2 illustrates a simplified block diagram of an exemplary vehicle installation artificial intelligence system for use with the process shown in FIG. 1.

FIG. 3 illustrates an exemplary configuration of a user computer device as shown in FIG. 2, in accordance with one embodiment of the present disclosure.

FIG. 4 illustrates an exemplary configuration of a server system as shown in FIG. 2, in accordance with one embodiment of the present disclosure.

FIG. 5 illustrates a view of an exemplary user interface for logging into the system shown in FIG. 2.

FIG. 6 illustrates a view for capturing a repair order number on the user interface shown in FIG. 5 using the system shown in FIG. 2 using the process shown in FIG. 1.

FIG. 7 illustrates a view for capturing a vehicle identification number on the user interface shown in FIG. 5 using the system shown in FIG. 2 using the process shown in FIG. 1.

FIG. 8 illustrates a view for capturing a part number on the user interface shown in FIG. 5 using the system shown in FIG. 2 using the process shown in FIG. 1.

FIG. 9 illustrates a view for capturing a serial number on the user interface shown in FIG. 5 using the system shown in FIG. 2 using the process shown in FIG. 1.

FIG. 10 illustrates a plurality of views for verifying installation of a part on the user interface shown in FIG. 5 using the system shown in FIG. 2 using the process shown in FIG. 1.

### DETAILED DESCRIPTION

The present embodiments may relate to, inter alia, systems, methods, computer programs, and computer networks for providing artificial intelligence feedback in a vehicle service and maintenance environment. In one exemplary embodiment, the methods may be performed by a vehicle installation artificial intelligence (“VIAI”) computer device. In the exemplary embodiment, the VIAI computer device is in communication with at least one repair facility server and at least one warranty provider server. In the exemplary embodiment, the VIAI computer device includes a camera and a display. In the exemplary embodiment, the VIAI computer device receives images through the camera and displays those images in real-time on the display.

As described below in more detail, the VIAI computer device may be configured to (i) receive, via the camera, a first image of a device identifier for the device; (ii) receive, via the camera, a second image of a part identifier for the part to be installed into the device; (iii) receive, via the camera, a third image of a serial identifier of the part to be installed into the device; (iv) compare the device identifier, the part identifier, and the serial identifier to validate the part; (v) receive, via the camera, a fourth image of the part after installation; (vi) determine whether the part was properly installed based on the fourth image; (vii) if the determination is that the part was not properly installed, instruct the display device to display a notification that the part was improperly installed; and (viii) if the determination is that the part was properly installed, store installation information.

In an exemplary embodiment, the VIAI computer device scans an identifier of a device into which a part is to be installed. In one example, the device is a vehicle, such as an automobile, and the identifier is the vehicle identification number (VIN). In at least one embodiment, the VIAI computer device captures an image of the VIN using the camera. The VIAI computer device recognizes and stores the VIN from the image. Then, the VIAI computer device scans a general part identifier, a part identifier, or a part number of part to be installed. In some embodiments, the VIAI computer device captures an image of the part number and determines the number using optical character recognition techniques. In other embodiments, the VIAI computer device captures an image of a bar code for the part and determines the part number from the bar code. Next, the VIAI computer device captures an image of the specific part identifier, serial number, or serial identifier of the part to be installed. Then, the VIAI computer device compares the device identifier, the general part identifier, and the specific part identifier to confirm that this is the correct part to be installed into the device. In some embodiments, the VIAI computer device provides instructions about the installation of the part into the device.

When the installation is complete, the VIAI computer device captures one or more images of the installed part and validates whether or not the part has been properly installed. In the exemplary embodiment, the VIAI computer device performs inference matching and template matching on the installed part to confirm that the part has been properly installed. In one example, the VIAI computer device may perform image recognition on the installed part and the installation location to confirm that the part has been properly installed. If the part was not properly installed, the VIAI computer device notifies the user. In some embodiments, the VIAI computer device instructs the user in the proper installation of the part.

If the part was properly installed, the VIAI computer device informs the user. Then, the VIAI computer device stores the installation information. In some embodiments, the installation information includes the device identifier, the part identifier, the serial identifier, and the image of the installed part. In other embodiments, the installation information also includes the images of the device identifier, the part identifier, and the serial identifier. In an exemplary embodiment, the VIAI computer device transmits the installation information to a warranty provider server to show that the part was properly installed. In one embodiment, VIAI computer device transmits the image of the properly installed part with the device identifier, the part number, and/or the serial number to the warranty provider server. In some embodiments, the VIAI computer device stores each piece of installation information as it is being captured.

In some further embodiments, the user points the VIAI computer device at the place where the part is to be installed; the VIAI computer device recognizes the location; and the VIAI computer device projects an overlay of the properly installed part onto the location, such as by projecting a wireframe overlay of the correctly installed part onto the live image of the installation location.

The methods and systems described herein may be implemented using computer programming or engineering techniques including computer software, firmware, hardware, or any combination or subset thereof, wherein the technical effects may be achieved by performing at least one of the following steps: (a) receive, via the camera, a first image of a device identifier for the device; (b) receive, via the camera, a second image of a part identifier for the part to be installed into the device; (c) receive, via the camera, a third image of a serial identifier of the part to be installed into the device; (d) compare the device identifier, the part identifier, and the serial identifier to validate the part; (e) receive, via the camera, a fourth image of the part after installation; (f) determine whether the part was properly installed based on the fourth image; (g) if the determination is that the part was not properly installed, instruct the display device to display a notification that the part was improperly installed; (h) if the determination is that the part was properly installed, store installation information, wherein the installation information includes the device identifier, the part identifier, the serial identifier, and the fourth image; (i) instruct the display device to display a notification that the part was properly installed, wherein the notification is displayed over the fourth image; (j) transmit the installation information to a warranty provider computer device; (k) identify the device associated with the device identifier based on the first image; (l) identify the part associated with the part identifier based on the second image; (m) transmit the device identifier, the part identifier, and the serial identifier to a repair facility computer device, wherein the repair facility computer device validates the device identifier, the part identifier, and the serial identifier, and provides a notification of validation to the computer device; (n) receive, via the camera, an image of a location for the installation; (o) instruct the display device to display the image of the location for the installation along with instructions for installing the part, wherein the instructions further include an overlay image of a properly installed part over the installation location; (p) validate the device identifier based on the first image; (q) if the device identifier is not validated, instruct the display device to display instructions to recapture the first image; (r) if the device identifier is validated, instruct the display device to display instructions to capture the second image; (s) validate the part identifier based on the second image; (t) if the device identifier is not validated, display instructions to recapture the second image; (u) if the device identifier is validated, display instructions to capture the third image; (v) receive, from the camera, a fifth image a work identifier for installation of the part in the device; and (w) validate the work identifier based on the fifth image.

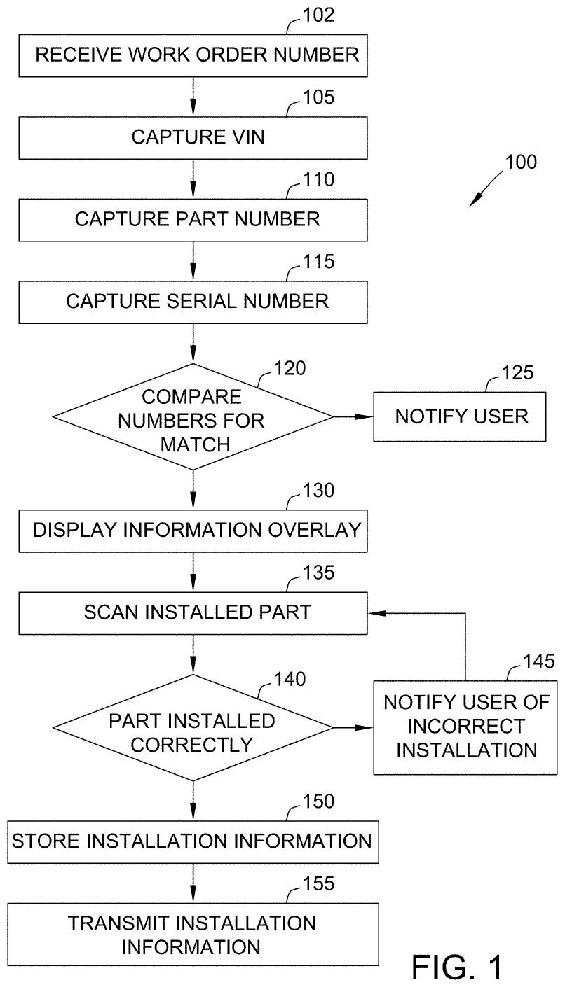

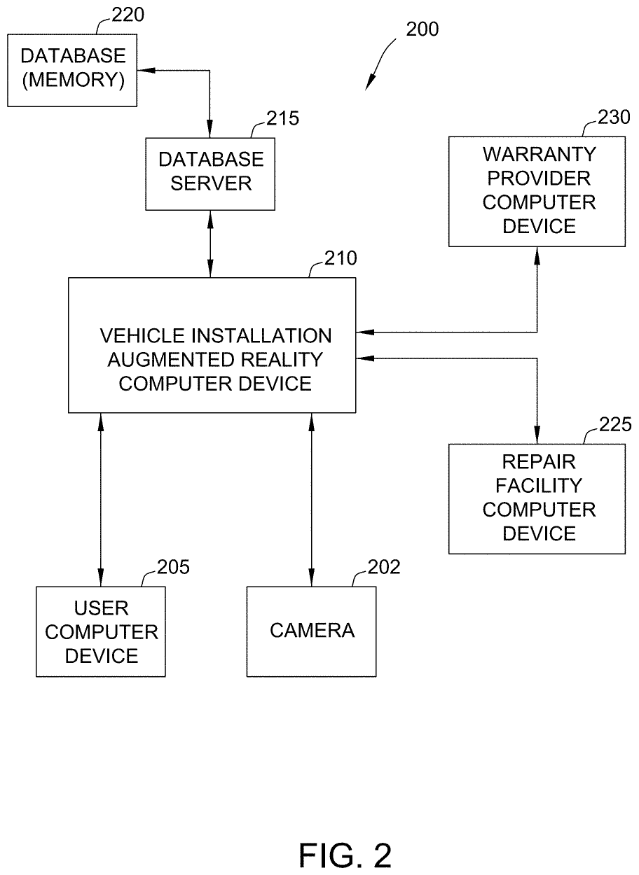

FIG. 1 illustrates a simplified data flow diagram of a process 100 for using artificial intelligence to ensure the correct part is properly installed in a vehicle in accordance with one embodiment of the disclosure. In an exemplary embodiment, process 100 is performed by VIAI computer device 210 (shown in FIG. 2). In other embodiments, process 100 is performed by a plurality of computer devices. While the vehicle may be an automobile in the exemplary embodiment, in other embodiments, the vehicle may be, but is not limited to, other types of ground craft, aircraft, spacecraft, and watercraft vehicles. Furthermore, while the description herein is related to vehicles, the systems described herein may be used for the installation of parts into other devices, such as computers, HVAC, assembly lines, elevators, escalators, and/or any other device requiring the proper installation of parts.

In an exemplary embodiment, the VIAI computer device 210 is in communication with at least one server computer device that stores device information, such as, but not limited to, vehicle identification numbers, part numbers, part serial numbers, work orders, repair orders, vehicle model information, part information, and installation information. In one exemplary embodiment, the VIAI computer device 210 includes a camera and a display device. In other embodiments, the VIAI computer device 210 is in communication with a camera.

In the exemplary embodiment, the user has a part to be installed in a device, such as a vehicle. In one exemplary embodiment, the VIAI computer device 210 receives 102 a work order (or repair order). In some embodiments, the user captures an image of the work order using the camera associated with the VIAI computer device 210, and the VIAI computer device 210 determines the information using optical character recognition. In other embodiments, the VIAI computer device 210 recognizes a work order number or a bar code on the work order and retrieves the information associated with that work order from a database, either a database stored on the VIAI computer device 210 or a database stored on a remote computer device. In other embodiments, the VIAI computer device 210 opens a file containing the work order. In one exemplary embodiment, the work order includes the part number and/or serial number of each of the parts to be installed. In some embodiments, the work order also includes the device identifier or vehicle identification number (VIN) of the device or vehicle that the work is to be performed on.

In the exemplary embodiment, the VIAI computer device 210 captures 105 the device identifier (such as the VIN of a vehicle). In some embodiments, the user points the camera associated with the VIAI computer device 210 at the device identifier of the device to capture 105 an image of the device identifier. The VIAI computer device 210 receives the image of the device identifier and determines the device identifier of the device from the image. The VIN may be determined using optical character recognition techniques or by reading an associated bar code. In some embodiments, the VIAI computer device 210 confirms that the bar code and the numbers of the device identifier match. In some embodiments, the VIAI computer device 210 receives the image of the device identifier from a remote computer device. In other embodiments, the VIAI computer device 210 transmits the image of the device identifier to a remote computer device, where the remote computer device determines the device identifier based on the image.

In the exemplary embodiment, the VIAI computer device 210 captures 110 the part number (also known as the general part number or part identifier) of the part to be installed in the vehicle. In some embodiments, the user points the camera associated with the VIAI computer device 210 at a label on the packaging for the part to capture 110 an image of the part number. In other embodiments, the user points the camera associated with the VIAI computer device 210 at the part itself to capture 110 an image of the part number. The VIAI computer device 210 receives the image of the part number and determines the part number of the part from the image. The part number may be determined using optical character recognition techniques or by reading an associated bar code. In some embodiments, the VIAI computer device 210 confirms that the bar code and the numbers of the part number match. In some embodiments, the VIAI computer device 210 receives the image of the part number from a remote computer device. In some embodiments, the VIAI computer device 210 transmits the image of the part number to a remote computer device, where the remote computer device determines the part number based on the image.

In the exemplary embodiment, the VIAI computer device 210 captures 115 the serial number (also known as the specific part number or serial identifier) of the part to be installed in the vehicle. In some embodiments, the user points the camera associated with the VIAI computer device 210 at a label on the packaging for the part to capture 115 an image of the serial number. In other embodiments, the user points the camera associated with the VIAI computer device 210 at the part itself to capture 115 an image of the serial number. The VIAI computer device 210 receives the image of the serial number and determines the serial number of the part from the image. The serial number may be determined using optical character recognition techniques or by reading an associated bar code. In some embodiments, the VIAI computer device 210 confirms that the bar code and the numbers of the serial number match. In some embodiments, the VIAI computer device 210 receives the image of the serial number from a remote computer device. In some embodiments, the VIAI computer device 210 transmits the image of the serial number to a remote computer device, where the remote computer device determines the serial number based on the image

In an exemplary embodiment, the VIAI computer device 210 compares 120 the information retrieved about the work order, the device identifier, the part number, and/or serial number to confirm that the correct part is about to be installed in the correct vehicle. In some embodiments, the VIAI computer device 210 compares one or more of the device identifier, the work order number, the part number, and the serial number of the part to confirm that this is the correct part and/or the proper procedure. In some embodiments, the VIAI computer device 210 determines the make and model of the device from the device identifier and confirms that the correct part is to be installed in the device. The VIAI computer device 210 can also confirm that the work order is for the correct device based on the device identifier. For example, the VIAI computer device 210 determines the make and model of the vehicle from the VIN, confirms that the correct part is to be installed in the vehicle, and confirms that the work order is for the correct vehicle based on the VIN. The VIAI computer device 210 can also confirm that the work order is for the correct part based on the part number and/or the serial number. For example, the VIAI computer device 210 may consult one or more databases to confirm this information. If there is a discrepancy, then the VIAI computer device 210 notifies 125 the user.

In some embodiments, the VIAI computer device 210 validates the work order number, the device identifier, the part number, and the serial number as the VIAI computer device 210 receives them. The VIAI computer device 210 can validate the numbers for format. For example, if the work order number is too short or too long, then the VIAI computer device 210 can notify 125 the user. The VIAI computer device 210 can compare the device identifier, the part number, and the serial number to the information on the work order and notify 125 the user of an issue. These validations can take place after each step 102-115.

The VIAI computer device 210 displays 130 information about the part and the device on the display device. In some embodiments, the VIAI computer device 210 displays one or more of the part number, the serial number, the work order number, the device number, instructions for installing the part (written or illustrations), and date/time information. Other information may be displayed based on the situation and the user preferences. In the exemplary embodiment, the VIAI computer device 210 uses machine learning techniques, such as neural networks, to assist with validating the device number, the part number, and the serial number. The VIAI computer device 210 can discover patterns in how each of the device number, the part number, and the serial number are formatted or generated and notify 125 the user when one or more of the device number, part number, and serial number violate that pattern, which can be an indication of a potential error or prevent the installation of the incorrect part.

After the part has been installed, the VIAI computer device 210 scans 135 the installed part. In one exemplary embodiment, the user points the camera associated with the VIAI computer device 210 at the installed part and the VIAI computer device 210 captures one or more images of the installed part.

When the installation is complete, the VIAI computer device 210 receives one or more images of the installed part and determines 140 whether or not the part has been properly installed. In the exemplary embodiment, the VIAI computer device performs inference matching and template matching on the installed part to confirm that the part has been properly installed. In one example, the VIAI computer device 210 performs image recognition on the installed part and the installation location to confirm that the part has been properly installed. (QUESTION TO INVENTORS: Are there any additional details about how the system determines if the part is properly installed?) If the part was not properly installed, the VIAI computer device 210 notifies 145 the user. In some embodiments, the VIAI computer device instructs the user in the proper installation of the part.

If the part was properly installed, the VIAI computer device 210 informs the user. Then, the VIAI computer device 210 stores 150 the installation information. In some embodiments, the installation information includes the device identifier, the part identifier, the serial identifier, and the image of the installed part. In other embodiments, the installation information also includes the images of the device identifier, the part identifier, and the serial identifier. In an exemplary embodiment, the VIAI computer device 210 transmits 155 the installation information to a remote computer device, such as a warranty provider server, to show that the part was properly installed. In some embodiments, the VIAI computer device stores each piece of installation information as it is being captured. In some embodiments, one or more of the work order number, the device number, the part number, and the serial number are stored as metadata, such as in the metadata of the image of the installed part.

In some embodiments, if the VIAI computer device 210 notifies 145 the user a predetermined number of times that the part is not properly installed, a supervisor can validate the installation of the part. If the installation has failed to be approved by the VIAI computer device 210 a certain number of times (i.e., three times) the VIAI computer device 210 can provide an override mode. In the override mode, a supervisor or other authorized user can enter that the part has been properly installed. In these embodiments, the VIAI computer device 210 displays an override verification entry screen that allows the supervisor or other authorized user to enter authentication data, such as, but not limited to, name, ID number, and password to approve the verification. The override verification entry screen may also include questions to confirm that the supervisor has inspected and verified that the part is installed correctly. This override verification information is stored 150 with the installation information

In some embodiments, the user captures 115 one or more images of the part to be installed using the camera associated with the VIAI computer device 210. In these embodiments, the VIAI computer device 210 recognizes the part number and/or serial number of the part from the one or more images of the part. In some embodiments, the VIAI computer device 210 uses optical character recognition technology and/or bar code scanning to identify the part number and/or serial number. In other embodiments, the VIAI computer device 210 identifies the part and the corresponding part number based on image recognition.

In some further embodiments, the user points the VIAI computer device 210 at the place where the part is to be installed; the VIAI computer device 210 recognizes the location; and the VIAI computer device 210 projects an overlay of the properly installed part onto the location, such as by projecting a wireframe overlay of the correctly installed part onto the live image of the installation location. In the exemplary embodiment, the VIAI computer device 210 displays the information as an overlay on top of live images captured by the camera. For example, while the user is pointing the camera at the location in the vehicle where the part is to be installed, the VIAI computer device 210 displays the view of the camera overlaid with information about the part to be installed.

In the exemplary embodiment, the VIAI computer device 210 receives a plurality of images of previous installations of the part into similar devices. The plurality of images of previous installations may include, but is not limited to, images at different angles, different lighting levels, with different parts installed into the device, with the same part installed in different devices, and other variations. The VIAI computer device 210 can also receive the data associated with each of these installations, such as, but not limited to, work order number, device identifier, part identifier, and serial identifier. Then the VIAI computer device 210 analyzes the plurality of information to detect one or more trends and to recognize from one or more images when an installation of a part in a device has been done properly. In addition, the VIAI computer device 210 can also determine when an issue may arise due to an irregularity from one or more of the associated numbers. For example, the VIAI computer device 210 may determine that the individual part cannot be installed in that particular make and model of device. The VIAI computer device 210 may also determine that there is a problem with a batch of parts within a specific range of serial numbers and flag the individual part as being within that range.

FIG. 2 illustrates a simplified block diagram of an exemplary vehicle installation artificial intelligence system 200 for use with the process 100 shown in FIG. 1. In the exemplary embodiment, system 200 may be used for assisting a user with installing a part into a vehicle or other machine and includes a vehicle installation artificial intelligence (“VIAI”) computer device 210. In some embodiments, a vehicle installation artificial intelligence application is executing on the VIAI computer device 210.

In an exemplary embodiment, VIAI computer device 210 is in communication with at least one camera 202. In some embodiments, the camera 202 is integrated into the VIAI computer device 210. In other embodiments, camera 202 is a separate device that is in communication with VIAI computer device 210, such as through a wired connection, i.e. a universal serial bus (USB) connection, or a wireless connection, i.e. a Bluetooth connection. In an exemplary embodiment, VIAI computer device 210 is in communication with a database server 215. The database server 215 may be communicatively coupled to a database 220 that stores data. In one embodiment, database 220 may include vehicle identification numbers, part numbers, part serial numbers, work orders, repair orders, vehicle model information, device information, part information, installation instructions, and installation information. In the exemplary embodiment, database 220 is stored remotely from VIAI computer device 210. In some embodiments, database 220 may be decentralized. In the exemplary embodiment, a user may access database 220 via user computer device 205 by logging onto VIAI computer device 210 or directly by accessing VIAI computer device 210, as described herein.

VIAI computer device 210 may be communicatively coupled with one or more user computer devices 205 and at least one repair facility computer device 225 or warranty provider computer device 230. In some embodiments, VIAI computer device 210 may be associated with, or is part of a computer network associated with a warranty provider or repair facility, or in communication with the repair facility computer device 225 or the warranty provider computer device 230. In other embodiments, VIAI computer device 210 may be associated with a third party and is merely in communication with the repair facility computer device 225 or the warranty provider computer device 230. More specifically, VIAI computer device 210 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

VIAI computer device 210 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, VIAI computer device 210 hosts an application or website that allows the user to access the functionality described herein. In some further embodiments, user computer device 205 includes an application that facilitates communication with VIAI computer device 210.

In the exemplary embodiment, user computer devices 205 are computers that include a web browser or a software application, which enables user computer devices 205 to access remote computer devices, such as VIAI computer device 210 and repair facility computer devices 225, using the Internet or other network. More specifically, user computer devices 205 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 205 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In an exemplary embodiment, repair facility computer devices 225 include computer devices associated with repair facilities capable of repairing the vehicle. In the exemplary embodiment, repair facility computer devices 225 include a web browser or a software application, which enables repair facility computer devices 225 to access remote computer devices, such as VIAI computer device 210, using the Internet or other network. More specifically, repair facility computer devices 225 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Repair facility computer devices 225 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, repair facility computer devices 225 may communicate with VIAI computer device 210 to transmit information about work orders. Repair facility computer devices 225 may communicate with database 220 to store and/or retrieve information about the installation of the part.

In the exemplary embodiment, warranty provider computer devices 230 include one or more computer devices associated with a warranty provider, such as the manufacturer or insurer of the vehicle. In the exemplary embodiment, warranty provider is associated with manufacturer of the vehicle and provides a warranty policy for the vehicle. In other embodiments, the warranty provider is an insurance provider that has provided an extended warranty policy for the vehicle, such as after the original warranty has expired. In the exemplary embodiment, warranty provider computer devices 230 include a web browser or a software application, which enables warranty provider computer devices 230 to access remote computer devices, such as VIAI computer device 210 and database server 215, using the Internet or other network. More specifically, warranty provider computer devices 230 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Warranty provider computer devices 230 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, warranty provider computer devices 230 may access database 220 to update part installation information.

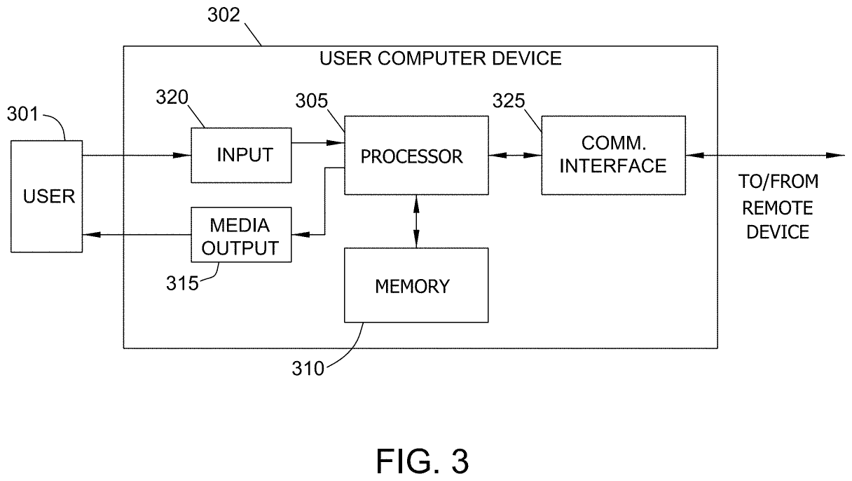

FIG. 3 illustrates an exemplary configuration of a user computer device as shown in FIG. 2, in accordance with one embodiment of the present disclosure. In the exemplary embodiment, user computer device 302 may be similar to, or the same as, user computer device 205 (shown in FIG. 2). User computer device 302 may be operated by a user 301. User computer device 302 may include, but is not limited to, user computer devices 205, VIAI computer device 210, repair facility computer devices 225, and warranty provider computer devices 230 (all shown in FIG. 2). User computer device 302 may include a processor 305 for executing instructions. In some embodiments, executable instructions may be stored in a memory area 310. Processor 305 may include one or more processing units (e.g., in a multi-core configuration). Memory area 310 may be any device allowing information such as executable instructions and/or transaction data to be stored and retrieved. Memory area 310 may include one or more computer readable media.

User computer device 302 may also include at least one media output component 315 for presenting information to user 301. Media output component 315 may be any component capable of conveying information to user 301. In some embodiments, media output component 315 may include an output adapter (not shown) such as a video adapter and/or an audio adapter. An output adapter may be operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 may be configured to present a graphical user interface (e.g., a web browser and/or a user application) to user 301. A graphical user interface may include, for example, an interface for viewing images and repair information.

In some embodiments, user computer device 302 may include an input device 320 for receiving input from user 301. User 301 may use input device 320 to, without limitation, select and/or enter one or more items of information about the work order and/or one or more images. In some embodiments, input device 320 may include a camera device, such as camera 202 (shown in FIG. 2). Input device 320 may also include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as VIAI computer device 210 (shown in FIG. 2). Communication interface 325 may include, for example, a wired or wireless network adapter and/or a wireless data transceiver for use with a mobile telecommunications network.

Stored in memory area 310 are, for example, computer readable instructions for providing a user interface to user 301 via media output component 315 and, optionally, receiving and processing input from input device 320. A user interface may include, among other possibilities, a web browser and/or a user application. Web browsers enable users, such as user 301, to display and interact with media and other information typically embedded on a web page or a website from VIAI computer device 210. A user application may allow user 301 to interact with, for example, VIAI computer device 210. For example, instructions may be stored by a cloud service, and the output of the execution of the instructions sent to the media output component 315.

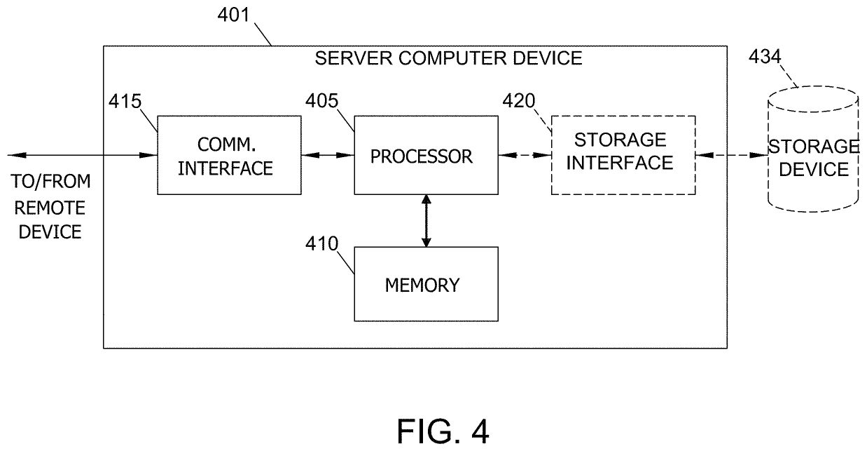

FIG. 4 depicts an exemplary configuration of a server system, in accordance with one embodiment of the present disclosure. Server computer device 401 may include, but is not limited to, VIAI computer device 210, database server 215, repair facility computer device 225, and warranty provider computer device 230 (all shown in FIG. 2). Server computer device 401 may also include a processor 405 for executing instructions. Instructions may be stored in a memory area 410. Processor 405 may include one or more processing units (e.g., in a multi-core configuration).

Processor 405 may be operatively coupled to a communication interface 415 such that server computer device 401 is capable of communicating with a remote device such as another server computer device 401, VIAI computer device 210, user computer device 205, repair facility computer device 225, and warranty provider computer device 230 (for example, using wireless communication or data transmission over one or more radio links or digital communication channels). For example, communication interface 415 may receive requests from repair facility computer device 225 and warranty provider computer device 230 via the Internet, as illustrated in FIG. 2.

Processor 405 may also be operatively coupled to a storage device 434. Storage device 434 may be any computer-operated hardware suitable for storing and/or retrieving data, such as, but not limited to, data associated with database 220 (shown in FIG. 2). In some embodiments, storage device 434 may be integrated in server computer device 401. For example, server computer device 401 may include one or more hard disk drives as storage device 434. In other embodiments, storage device 434 may be external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 may be operatively coupled to storage device 434 via a storage interface 420. Storage interface 420 may be any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

Processor 405 may execute computer-executable instructions for implementing aspects of the disclosure. In some embodiments, the processor 405 may be transformed into a special purpose microprocessor by executing computer-executable instructions or by otherwise being programmed. For example, the processor 405 may be programmed with the instructions.

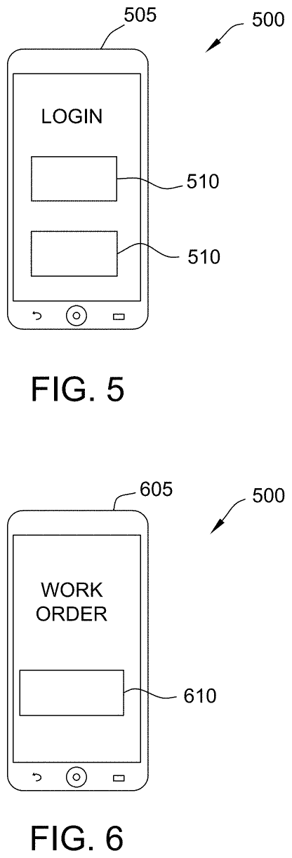

FIG. 5 illustrates a view of an exemplary user interface 500 for logging into the system 200 (shown in FIG. 2). In the exemplary embodiment, user interface 500 is displayed on VIAI computer device 210 (shown in FIG. 2).

View 505 of the user interface 500 displays a series of entry fields 510, wherein the user can enter login information to access the vehicle installation artificial intelligence application executing on the VIAI computer device 210. In the exemplary embodiment, the user inputs credentials into the entry fields 510 to authorize the user to access the system 200. The credentials can include, but are not limited to, company name, identification number, username, user identifier number, password, or any other login credential that the system 200 requests. If the user does not have valid credentials, the user is notified that there is insufficient authorization and the VIAI computer device 210 returns to the login screen shown in view 505.

FIG. 6 illustrates a view for capturing a repair order number on the user interface 500 (shown in FIG. 5) using the system 200 (shown in FIG. 2) using the process 100 (shown in FIG. 1). In the exemplary embodiment, user interface 500 is displayed on VIAI computer device 210 (shown in FIG. 2).

A repair order entry view 605 of the user interface 500 displays one or more work order entry number fields 610 to allow the user to enter the work order number, a repair order number, job number, or any other appropriate identifier to be validated. If the work order number is not validated, such as by having too few or too many numbers, or by being associated with an already completed repair order, then the VIAI computer device 210 provides an error message and returns to displaying the work order entry view 605.

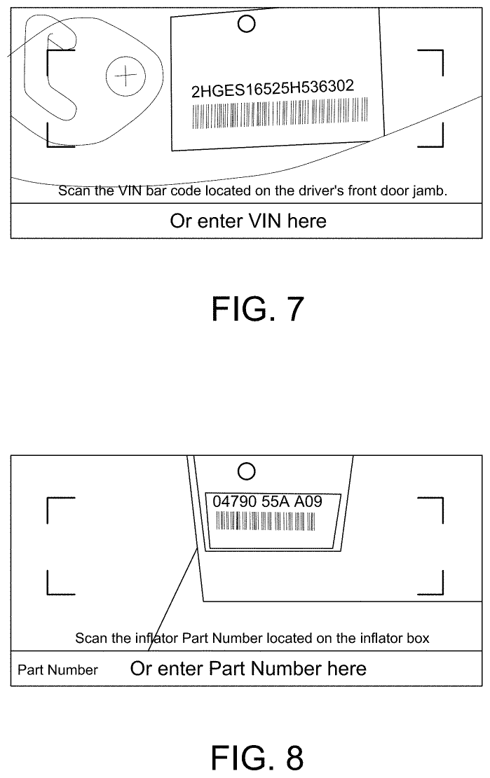

FIG. 7 illustrates a view for capturing a vehicle identification number on the user interface 500 (shown in FIG. 5) using the system 200 (shown in FIG. 2) using the process 100 (shown in FIG. 1).

A VIN entry view 705 displays instructions to the user how to capture the VIN on a vehicle. The VIN entry view 705 displays a view of the user using the camera 202 (shown in FIG. 2) of the VIAI computer device 210 to capture images of the VIN. The VIN entry view 705 includes a framing bracket 710 to assist the user in capturing an image of the VIN. In the exemplary embodiment, the VIAI computer device 210 receives a current view of the camera 202 and projects that current view along with the framing bracket 710 to the user on the display device. When the user has framed the VIN properly, the user can press a button to capture and save the image. In some embodiments, the VIAI computer device 210 determines when the user has framed the VIN properly and automatically captures the image at that point. The VIAI computer device 210 determines the VIN of the vehicle based on those images. If the image is improperly framed or out of focus, the VIAI computer device 210 displays an error message for capturing the VIN of the vehicle. In some embodiments, the VIAI computer device 210 determines that the VIN is not associated with the previously entered work order and displays an error message to indicate that this is the incorrect vehicle for the work order. While the VIN entry view 705 is based on a vehicle and a VIN, the entry view could be reused for any device and device identifier.

As shown in the VIN entry view 705, the user interface 500 displays the numerical value for the VIN as well as the associated bar code. The VIAI computer device 210 can use either the numerical value and/or the associated bar code to determine the VIN. Furthermore, the VIN entry view 705 includes an entry field 715 to manually enter the VIN.

FIG. 8 illustrates a view 805 for capturing a part number on the user interface 500 (shown in FIG. 5) using the system 200 (shown in FIG. 2) using the process 100 (shown in FIG. 1).

The part number entry view 805 displays instructions to the user how to capture the part number of the part. The part number entry view 805 displays a view of the user using the camera 202 (shown in FIG. 2) of the VIAI computer device 210 to capture images of the part number. The VIAI computer device 210 determines the part number of the part based on those images. The part number entry view 805 includes a framing bracket 810 to assist the user in capturing an image of the part number. In the exemplary embodiment, the VIAI computer device 210 receives a current view of the camera 202 and projects that current view along with the framing bracket 810 to the user on the display device. When the user has framed the part number properly, the user can press a button to capture and save the image. In some embodiments, the VIAI computer device 210 determines when the user has framed the part number properly and automatically captures the image at that point. The VIAI computer device 210 determines the part number based on those images. If the image is improperly framed or out of focus, the VIAI computer device 210 displays an error message for capturing the part number. In some embodiments, the VIAI computer device 210 determines that the part number is not associated with the previously entered work order and displays an error message to indicate that this is the incorrect part for the work order.

As shown in the part number entry view 805, the user interface 500 displays the numerical value for the part number as well as the associated bar code. The VIAI computer device 210 can use either the numerical value and/or the associated bar code to determine the part number. Furthermore, the part number entry view 805 includes an entry field 815 to manually enter the part number.

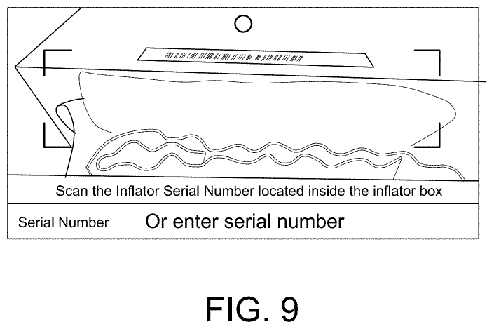

FIG. 9 illustrates a view 905 for capturing a serial number on the user interface 500 (shown in FIG. 5) using the system 200 (shown in FIG. 2) using the process 100 (shown in FIG. 1).

The serial number entry view 905 displays instructions to the user how to capture the serial number of the part. The serial number entry view 905 displays a view of the user using the camera 202 (shown in FIG. 2) of the VIAI computer device 210 to capture images of the serial number. The serial number entry view 905 includes a framing bracket 910 to assist the user in capturing an image of the VIN. In the exemplary embodiment, the VIAI computer device 210 receives a current view of the camera 202 and projects that current view along with the framing bracket 910 to the user on the display device. When the user has framed the serial number properly, the user can press a button to capture and save the image. In some embodiments, the VIAI computer device 210 determines when the user has framed the serial number properly and automatically captures the image at that point. The VIAI computer device 210 determines the serial number of the part based on those images. If the image is improperly framed or out of focus, the VIAI computer device 210 displays an error message for capturing the serial number of the part. In some embodiments, the VIAI computer device 210 determines that the serial number is not associated with the previously entered work order or the part number and displays an error message to indicate that this is the incorrect part for the work order.

As shown in the serial number entry view 905, the user interface 500 displays the numerical value for the serial number as well as the associated bar code. The VIAI computer device 210 can use either the numerical value and/or the associated bar code to determine the serial number. Furthermore, the serial number entry view 905 includes an entry field 915 to manually enter the serial number.

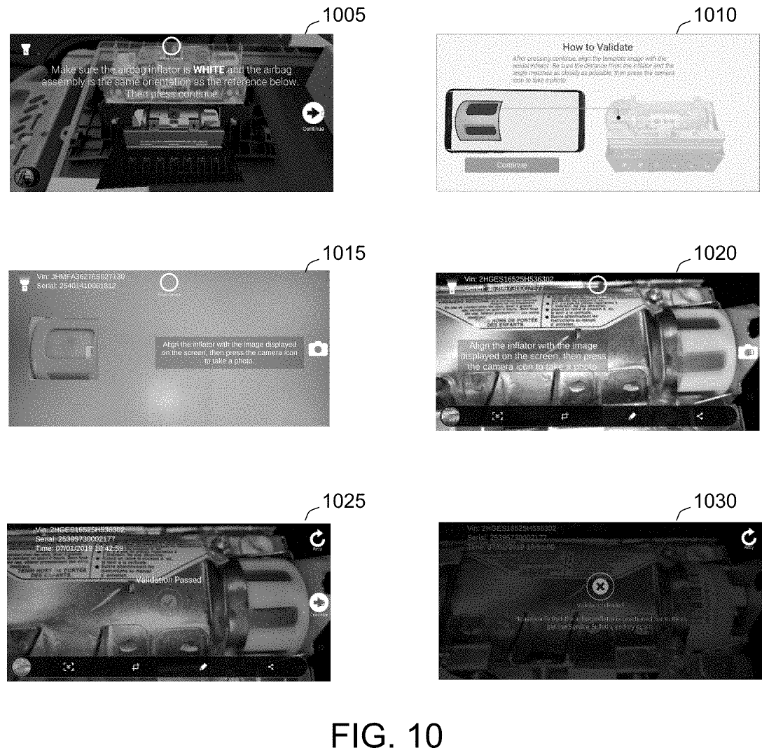

FIG. 10 illustrates a plurality of views for verifying installation of a part on the user interface 500 (shown in FIG. 5) using the system 200 (shown in FIG. 2) using the process 100 (shown in FIG. 1).

A first part installation view 1005 displays instructions for the proper installation of the part. A second part installation view 1010 displays instructions for validating the installation of the part. A third part installation view 1015 and a fourth part installation view 1020 display different methods for capturing the image of the installed part using the camera 202 (shown in FIG. 2) associated with the VIAI computer device 210. A fifth part installation view 1125 displays a successful installation message. A sixth part installation view 1130 display a failed installation message.

In an exemplary embodiment, the VIAI computer device 210 provides instructions for the user to align the installed part with the outline of the part or other indicators displayed on the screen. In the exemplary embodiment, the VIAI computer device 210 performs image recognition on the part and the installation of the part to determine if the part has been properly installed. In the images shown herein, the VIAI computer device 210 may detect a part element at one end of the installed part and determine if it is the correct shape. Then, the VIAI computer device provides feedback on the installation of the part.

In some embodiments, VIAI computer device 210 or user computer device 205 compares the live camera view with an orientation model to determine whether or not the live camera view is showing the properly framed image. In some embodiments, the orientation model may be a three-dimensional wireframe model of the vehicle and/or the part that is used to generate views of the object. If the view of the object in the image matches the view of the orientation model of the object, then the image is properly framed. This may be used for images of bar codes, numbers, parts, and installation locations.

In some embodiments, the camera 202 may be constantly taking low quality pictures, which are being displayed in live camera view. In other embodiments, the camera 202 may continuously capture high quality images and/or video necessary for analysis. In these embodiments, the camera 202 may capture a high quality picture when camera 202 is pointed at the proper angle and at the correct position. In these embodiments, instructions may instruct the user to wait while the picture and/or image is being captured. For example, a feedback indicator may be displayed in user interface 500 that turns green to show that the user is holding the camera 202 at the correct position. In one example, the feedback indicator shows a large check mark when the process of capturing the image is complete. In some embodiments, a thumbnail of the captured image or a cropped version of the image may be shown in the one or more selected camera views.

In some embodiments, the VIAI computer device 210 may determine that the part has not been installed properly when the part has been properly installed. If the installation has failed to be approved by the VIAI computer device 210 a certain number of times (i.e., three times) the VIAI computer device 210 can provide an override mode. In the override mode, a supervisor or other authorized user can enter that the part has been properly installed. In these embodiments, the VIAI computer device 210 displays an override verification entry screen that allows the supervisor or other authorized user to enter authentication data, such as, but not limited to, name, ID number, and password to approve the verification. The override verification entry screen may also include questions to confirm that the supervisor has inspected and verified that the part is installed correctly. This override verification information is stored 150 (shown in FIG. 1) with the installation information.

At least one of the technical solutions to the technical problems provided by this system may include: (i) improving the instruction to users in the installation of parts; (ii) confirming that the user installation of a part is correct; (iii) confirming all of the information about installation of a part is correct prior to installation; (iv) reducing confusion about part installation; (v) saving information about the properly installed parts for future reference; (vi) allowing for part installation validation without requiring specialized equipment; and (vii) providing images of properly installed parts to warranty systems.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics and information, historical work orders, and/or actual installation images. The machine learning programs may utilize deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the device, vehicle, user, part, installation requirements, vehicle and/or device requirements, image data, and/or other data.

Based upon these analyses, the processing element may learn how to identify characteristics and patterns that may then be applied to analyzing image data, model data, and/or other data. For example, the processing element may learn, with the user's permission or affirmative consent, to identify the type of installation error that occurred based upon images of the resulting installation. The processing element may also learn how to identify installation information that may not be readily visible based upon the received image data.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a server computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom), or any other type of operating system environment. The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment,” “exemplary embodiment,” or “one embodiment” of the present disclosure are not intended to be interpreted as excluding the existence of additional embodiments that also incorporate the recited features.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer device for validating the installation of a part in a device, the computer device comprising at least one memory in communication with at least one processor, wherein the at least one processor is also in communication with a camera and a display device, the at least one processor programmed to:
receive, via the camera, a first image of a device identifier for the device;
receive, via the camera, a second image of a part identifier for the part to be installed into the device;
receive, via the camera, a third image of a serial identifier of the part to be installed into the device;
compare the device identifier, the part identifier, and the serial identifier to validate the part;
receive, via the camera, a fourth image of the part after installation;
determine whether the part was properly installed based on the fourth image;
if the determination is that the part was not properly installed, instruct the display device to display a notification that the part was improperly installed; and
if the determination is that the part was properly installed, store installation information.

2. The computer device in accordance with claim 1, wherein the installation information includes the device identifier, the part identifier, the serial identifier, and the fourth image.

3. The computer device in accordance with claim 1, wherein the at least one processor is further programmed to instruct the display device to display a notification that the part was properly installed, wherein the notification is displayed over the fourth image.

4. The computer device in accordance with claim 1, wherein the at least one processor is further programmed to transmit the installation information to a warranty provider computer device.

5. The computer device in accordance with claim 1, wherein the at least one processor is further programmed to:
identify the device associated with the device identifier based on the first image; and
identify the part associated with the part identifier based on the second image.

6. The computer device in accordance with claim 1, wherein the at least one processor is further programmed to transmit the device identifier, the part identifier, and the serial identifier to a repair facility computer device, wherein the repair facility computer device validates the device identifier, the part identifier, and the serial identifier, and provides a notification of validation to the computer device.

7. The computer device in accordance with claim 1, wherein the at least one processor is further programmed to:
receive, via the camera, an image of a location for the installation; and
instruct the display device to display the image of the location for the installation along with instructions for installing the part.

8. The computer device in accordance with claim 7, wherein the instructions further include an overlay image of a properly installed part over the installation location.

9. The computer device in accordance with claim 1, wherein the at least one processor is further programmed to:
validate the device identifier based on the first image;
if the device identifier is not validated, instruct the display device to display instructions to recapture the first image; and
if the device identifier is validated, instruct the display device to display instructions to capture the second image.

10. The computer device in accordance with claim 1, wherein the at least one processor is further programmed to:
validate the part identifier based on the second image;
if the device identifier is not validated, display instructions to recapture the second image; and
if the device identifier is validated, display instructions to capture the third image.

11. The computer device in accordance with claim 1, wherein the at least one processor is further programmed to:
receive, from the camera, a fifth image a work identifier for installation of the part in the device; and
validate the work identifier based on the fifth image.

12. A computer-implemented method for validating the installation of a part in a device, the method implemented by a computer device comprising at least one memory in communication with at least one processor, wherein the at least one processor is also in communication with a camera and a display device, the method comprising:
receiving, via the camera, a first image of a device identifier for the device;
receiving, via the camera, a second image of a part identifier for the part to be installed into the device;
receiving, via the camera, a third image of a serial identifier of the part to be installed into the device;
comparing the device identifier, the part identifier, and the serial identifier to validate the part;
receiving, via the camera, a fourth image of the part after installation;
determining whether the part was properly installed based on the fourth image;
if the determination is that the part was not properly installed, instructing the display device to display a notification that the part was improperly installed; and
if the determination is that the part was properly installed, storing installation information.

13. The method in accordance with claim 12, wherein the installation information includes the device identifier, the part identifier, the serial identifier, and the fourth image.

14. The method in accordance with claim 12 further comprising:
identifying the device associated with the device identifier based on the first image; and
identifying the part associated with the part identifier based on the second image.

15. The method in accordance with claim 12 further comprising transmitting the device identifier, the part identifier, and the serial identifier to a repair facility computer device, wherein the repair facility computer device validates the device identifier, the part identifier, and the serial identifier, and provides a notification of validation to the computer device.

16. A system for validating the installation of a part in a device, the system comprising:
at least one memory;
a camera;
a display device; and
at least one processor in communication with the at least one memory, the camera, and the display device, the at least one processor programmed to:
receive, via the camera, a first image of a device identifier for the device;
receive, via the camera, a second image of a part identifier for the part to be installed into the device;
receive, via the camera, a third image of a serial identifier of the part to be installed into the device;
compare the device identifier, the part identifier, and the serial identifier to validate the part;
receive, via the camera, a fourth image of the part after installation;
determine whether the part was properly installed based on the fourth image;
if the determination is that the part was not properly installed, instruct the display device to display a notification that the part was improperly installed; and
if the determination is that the part was properly installed, store installation information.

17. The system in accordance with claim 16, wherein the at least one processor is further programmed to instruct the display device to display a notification that the part was properly installed, wherein the notification is displayed over the fourth image.

18. The system in accordance with claim 16, wherein the installation information includes the device identifier, the part identifier, the serial identifier, and the fourth image.

19. The system in accordance with claim 16, wherein the at least one processor is further programmed to:
identify the device associated with the device identifier based on the first image; and
identify the part associated with the part identifier based on the second image.

20. The system in accordance with claim 16, wherein the at least one processor is further programmed to transmit the device identifier, the part identifier, and the serial identifier to a repair facility computer device, wherein the repair facility computer device validates the device identifier, the part identifier, and the serial identifier, and provides a notification of validation to the computer device.
